(19) United States
(12) Patent Application Publication
(10) Pub. No.: US 2014/0049703 A1
(43) Pub. Date: Feb. 20, 2014

(54) PEN WRITING ON ONE-DIMENSIONAL CAPACITIVE TOUCH SENSOR

(71) Applicant: Touchplus Information Corp., New Taipei City (TW)

(72) Inventor: Shih Hsien HU, New Taipei City (TW)

(73) Assignee: Touchplus Information Corp., New Taipei City (TW)

(21) Appl. No.: 14/029,753

(22) Filed: Sep. 17, 2013

(30) Foreign Application Priority Data
Aug. 18, 2012 (TW) 101134178

(51) Int. Cl. G02F 1/1333

(52) U.S. Cl. CPC G02F 1/13338
USPC 349/12; 29/622

(57) ABSTRACT

A touch panel detects capacitance variation based on the bending of the pattern layer caused by the pressure that the pen exerts on the pattern layer rather than based on the conductance that the pen directly exerts on the pattern layer.

### CROSS-REFERENCE TO RELATED APPLICATION

This application claims the benefit of TAIWAN patent application no. 101134178, filed Sep. 18, 2012, which are herein incorporated by reference in its integrity.

### TECHNICAL FIELD

The invention relates to the capacitive touch sensor and, in particular, to the one-dimensional capacitive touch sensor with pen writing function.

### BACKGROUND OF THE RELATED ART

Capacitive sensing is a technology based on capacitive coupling which takes human body capacitance as input. The capacitive touch sensor has been widely used in smart phones, tablets and even in the IT displays up to 23 inches, e.g. Notebooks, laptop trackpads, digital audio players, computer displays, ALL-in-one PCs, with the multi-touch features.

More and more design engineers are selecting capacitive sensors for their versatility, reliability and robustness, unique human-device interface and cost reduction over mechanical switches.

Capacitive sensors detect anything that is conductive or has a dielectric different than that of air. While capacitive sensing applications can replace mechanical buttons with capacitive alternatives, other technologies such as multi-touch and gesture-based touch screens are also premised on capacitive sensing.

Capacitive sensors are constructed from many different media, such as copper, Indium Tin Oxide (ITO) and printed ink. Copper capacitive sensors can be implemented on Printing Circuit Boards (PCBs) as well as on flexible material. Indium Tin Oxide allows the capacitive sensor to be up to 90% transparent for one layer solutions, such as touch phone screens.

In the industry of resistive touch panel, the pen writing has been used for many years. The most critical part of the resistive touch panel is the reliability issue. The resistive film is easily worn out after the intensive usage. The resistive touch panel provides the writing experience close to the writing habit of people, and the tip of the pen can be small enough to have higher writing resolution.

In the meanwhile, the technique of the projected capacitive touch panel, which measures the variation of capacitance where the fingers are touching, also advances.

FIGS. 1A and 1B show the structures of the traditional two-dimensional sensor arrays (110, 120). To have better coordination accuracy of the touched locations, the touch sensors often come with two-dimensional sensor arrays, including Double-sided Indium Tin Oxide (DITO) or Single-sided Indium Tin Oxide (SITO). The size of the sensor element from the sensor array is about the fingertip size (5-8 mm). The patterns of the sensor elements are mostly the bar shape, the diamond shape or other polygon shapes. For example, FIG. 1A shows that the pattern of the sensor elements (118, 116) in a two-dimensional sensor array 110 is the bar shape, and the two-dimensional sensor array 110 includes a bottom layer 112 and a top layer 114. FIG. 1B shows that the pattern of the sensor element 122 in a two-dimensional sensor array 120 is the diamond shape.

In general, the two-dimensional sensor array constructed as a matrix-like or keyboard-like structure has less constraint on the trace routing and provides better touch accuracy comparing to the one-dimensional sensor array for multi-touch applications. However, the two-dimensional sensor array costs higher than one-dimensional sensor array in manufacturing.

To have a better Signal to Noise Ratio (SNR) measurement for the finger identification in the traditional sensor array, the area touched by the finger can not be too small, and the required diameter of the area touched by the finger is about 6 to 9 mm. The required area is too large, and thus it is difficult to do the sophisticated pen writing on the capacitive touch screen, especially for the Chinese characters.

FIG. 2 shows the perspective view of another traditional capacitive touch displayer incorporating a digitizer at the backside. The capacitive touch displayer 200 includes a capacitive touch panel 202, a thin film transistor liquid crystal module (TFT LCM) panel 204, and a digitizer panel 206. The traditional capacitive touch displayer with an additional digitizer or an active writing pen provides the pen writing function, but needs the extra cost.

Thus, the traditional capacitive touch displayer has the following drawbacks: (1) the cost is then increased dramatically; (2) the specific digitizer pen is required; (3) the complex mechanical design is required to avoid the signal interference; and (4) the entire device gets thicker.

Therefore, it is desirable to create a capacitive touch sensor to resolve the above-mentioned issues.

### SUMMARY

The invention aims to resolve the above-mentioned issues. The invention provides the one-dimensional capacitive touch sensor with pen writing function.

The invention can achieve the following advantages effects: (1) not only the finger of a human body but also all kinds of pens or styluses can be used, including: a conductive pen with large tip 6 mm to 8 mm in diameter, a specifically active pen with built-in electronics, or a general pen with smaller tip 1 mm to 2 mm in diameter; (2) user-friendly writing which can be operated as a normal pen; (3) higher writing resolutions with smaller tip, which benefits writing complex characters; (4) lower cost with the one-dimensional single layer touch panel module compared to the two-dimensional touch modules; and (5) no specific touch pen, e.g., conductive pen or active pen with electronic circuits, is required.

An embodiment of the invention provides a touch panel comprising: a base serving as a ground; a flexible dielectric layer over the base; and a single pattern layer with sensor cells positioned over the flexible dielectric layer wherein the sensor cells form a sensor array, wherein capacitance is electrically formed from each of the sensor cells to the base, and deformation of the flexible dielectric layer generated by applying an external force results in different capacitance of one of the sensor cells when the deformation makes distance from the one of the sensor cells to the base change.

Another embodiment of the invention provides a touch panel comprising: a liquid crystal module for displaying images and serving as a ground; a pattern layer with sensor cells positioned over the liquid crystal module wherein the sensor cells form a sensor array; a lens positioned over the sensor array for shielding the sensor array; gaskets positioned between the lens and the liquid crystal module; and a spacer film positioned inside the gaskets and under the pattern layer such that a gap is formed between the spacer film and the liquid crystal module, wherein the spacer film and the lens are flexible, and the gap is used for allowing deformation of the lens and spacer film; and capacitance is electrically formed from each of the sensor cells to the liquid crystal module, and the capacitance varies when the pattern layer is bended by an external force.

Another embodiment of the invention provides a touch panel comprising: a liquid crystal module for displaying images and serving as a ground; a pattern layer with sensor cells positioned over the liquid crystal module wherein the sensor cells form a sensor array; a lens for covering the pattern layer; a spacer film positioned between the liquid crystal module and the lens, and under the pattern layer; gaskets positioned between the spacer film and the liquid crystal module such that a gap is formed between the spacer film and the liquid crystal module, wherein the spacer film and the lens are flexible, and the gap is used for allowing the deformation of the lens and the spacer film; and capacitance is electrically formed from each of the sensor cells to the liquid crystal module, and the capacitance varies when the pattern layer is bended by an external force.

Another embodiment of the invention provides a method for producing a touch panel comprising steps of: forming a base serving as a ground; forming a flexible dielectric layer over the base; and forming a single pattern layer with sensor cells of a sensor array positioned over the flexible dielectric layer, wherein capacitance is electrically formed from each of the sensor cells to the base, and deformation of the flexible dielectric layer generated by applying an external force results in different capacitance of one of the sensor cells when the deformation makes distance from the one of the sensor cells to the base change.

### BRIEF DESCRIPTION OF THE DRAWINGS

The primitive objectives and advantages of the present invention will become apparent upon reading the following description and upon reference to the accompanying drawings in which:

FIGS. 1A and 1B show the structures of the traditional two-dimensional sensor arrays;

FIG. 2 shows the perspective view of another traditional capacitive touch displayer incorporating a digitizer at the backside;

FIG. 3 shows the one-dimensional pattern used in a capacitive touch sensor according to an embodiment of the invention;

FIG. 4 illustrates the sectional view of a capacitive touch panel with the single pattern layer according to an embodiment of the invention;

FIG. 5A shows that each sensor cell of the capacitive touch panel illustrated in FIG. 4 has the constant capacitance to the liquid crystal module which serves as the ground;

FIG. 5B shows that the capacitance from each sensor cell of the capacitive touch panel illustrated in FIG. 4 to the liquid crystal module has been changed due to the mechanics changes resulted from the pressure exerted by the pen;

FIG. 6 illustrates a one-dimensional sensor array with the honeycomb shape pattern according to another embodiment of the invention;

FIG. 7 illustrates the sectional view of a capacitive touch panel with the single pattern layer and the one glass solution structure according to another embodiment of the invention; and

FIG. 8 illustrates the sectional view of a capacitive touch panel with Indium Tin Oxide (ITO) lens plus Polyethylene Terephthalate (PET) film structure according to another embodiment of the invention.

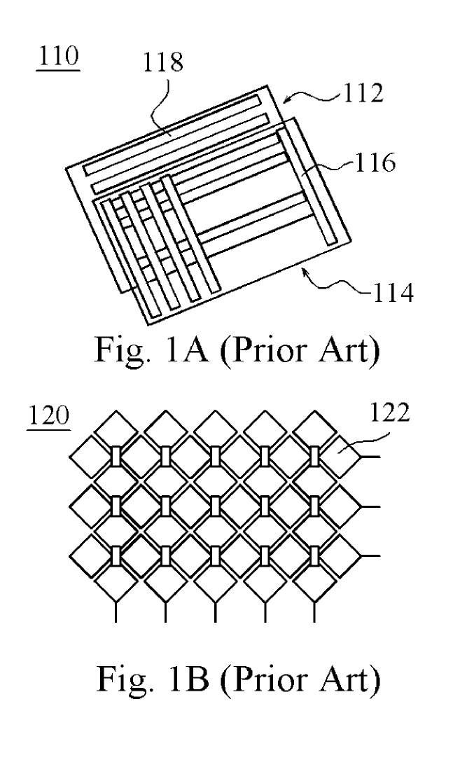

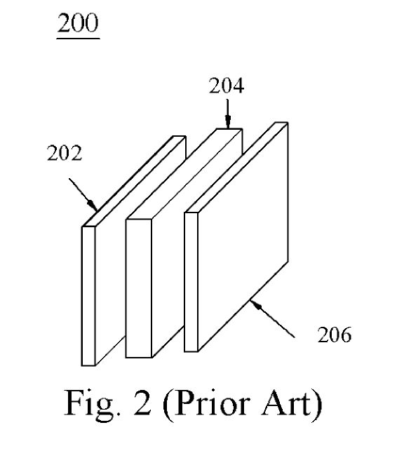

### DETAILED DESCRIPTION

In order to fully understand the manner in which the above-recited details and other advantages and objects according to the invention are obtained, a more detailed description of the invention will be rendered by reference to the best-contemplated mode and specific embodiments thereof. The following description of the invention is made for the purpose of illustrating the general principles of the invention and should not be taken in a limiting sense; it is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section. Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

Preferred embodiments and aspects of the invention will be described to explain the scope, structures and procedures of the invention. In addition to the preferred embodiments of the specification, the present invention can be widely applied in other embodiments.

The invention provides the one-dimensional single layer touch sensor with the mechanism of pen writing function, and achieves the pen writing function on the applications with the multi-touch function.

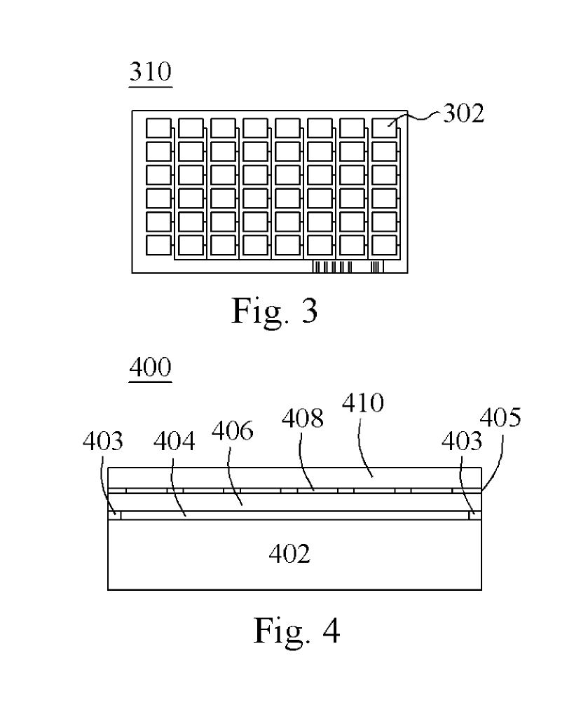

FIG. 3 shows the one-dimensional pattern used in a capacitive touch sensor according to an embodiment of the invention. Each sensor cell 302 on the one-dimensional pattern 300 can be individually controlled and sensed. For example, each sensor is a separate terminal, and corresponding to an independent sensing line, which is exclusive to the sensor. The shape of sensor cell 302 can be triangle, square, hexagon, and other geometric shapes. The one-dimensional pattern 300 can provides the multi-touch function and cost less than two-dimensional touch sensors in manufacturing.

Traditionally, to have the pen writing on a capacitive touch panel, the pen should be conductive and the diameter of the pen tip should be around 6 mm to 9 mm. However, the pen used in the touch sensor could be non-conductive and the diameter of the tip of the pen can be less than 2 mm according to an embodiment of the invention.

FIG. 4 illustrates the sectional view of a capacitive touch panel with the single pattern layer according to an embodiment of the invention. The capacitive touch panel comprises: a base 402 serving as a ground; and a single pattern layer 405 with sensor cells 408 positioned over the base 402 wherein the sensor cells 408 form a sensor array. The capacitive touch panel further comprises a lens 410 for covering the single pattern layer 405. Alternatively, the base 402 could be a liquid crystal module for displaying images, or a printing circuit board (PCB) when the liquid crystal module is not required, for example, a keyboard, or a touch pad.

Further, the single pattern layer 405 with the sensor cells 408 are formed on a flexible dielectric layer 406, and the flexible dielectric layer 406 is positioned over the base 402.

Optionally, The gaskets 403 is positioned between the flexible dielectric layer 406 and the base 402 to form a gap 404 between the flexible dielectric layer 406 and the base 402 wherein the gap 404 is used for allowing the deformation of the flexible dielectric layer 406.

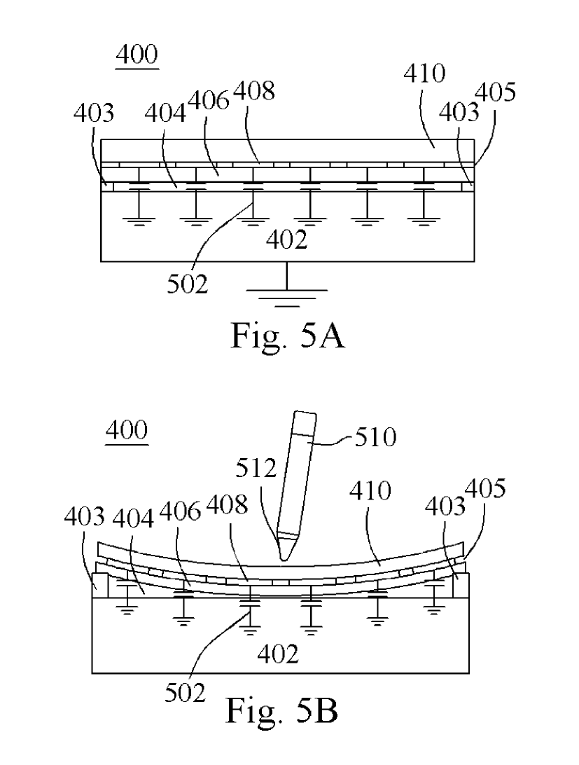

FIG. 5A shows that each sensor cell 408 of the capacitive touch panel 400 illustrated in FIG. 4 has the constant capacitance 502 to the base 402 which serves as the ground.

FIG. 5B shows that the capacitance 502 from each sensor cell 408 of the capacitive touch panel 400 illustrated in FIG. 4 to the base 402 has been changed due to the mechanics changes, such as deformation, resulted from the pressure exerted by the pen 510. This pressure is referred to the writing force from the pen 510. The pen 510 could be made of non-conductive material, such that the capacitance variation is completely from the mechanics changes resulted from the writing force.

Thus, the detection mechanism of capacitance variation is not based on the conductance that the pen directly exerts on the single pattern layer 405, but based on the bending of the single pattern layer 405 caused by the pressure that the pen exerts on the single pattern layer 405. Therefore, the material of the pen in the invention can be non-conductive, and the pen tip 512 can be reduced to be less than 2 mm diameter. And, the invention achieves the pen writing function with better writing resolution on the capacitive touch panel than the resistive touch panel.

Alternatively, the pen 510 could be replaced by the fingers of the user. By detecting the capacitance variation while the fingers are touching the sensor cells, the finger positions can be identified.

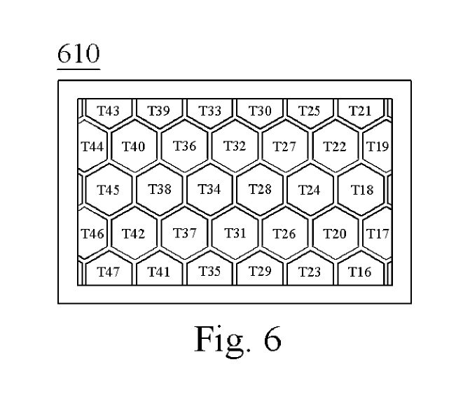

FIG. 6 illustrates a one-dimensional sensor array 610 with the honeycomb shape pattern according to another embodiment of the invention. Wherein, the sensor cell T28 is the target cell touched by the pen. The pen could be made of non-conductive material and the diameter of tip could be around 1 mm to 2 mm. The sensor array 610 comprises a flexible dielectric layer which may be the film or the glass sheet; sensor elements, which may be transparent, fabricated on the flexible dielectric layer. The sensor elements are formed with hexagon shapes and the pattern of the entire sensor elements is arranged to have the honeycomb configuration. As shown in the figure, the pluralities of the individual hexagons are arranged side by side with seven hexagons to form a unit. One hexagon is surrounded by six adjacent hexagons. The center sensor element may indicate one output signal when it is touched, and the center sensor element with one of the adjacent sensor elements may indicate another output signal when the two sensor elements are touched. By the same reason, the combination of three, four and more sensor element may be used to indicate certain output signal. Therefore, the unit of the sensor configuration may provide multiple output signals to indicate different instructions. The sensor elements are electrically connected to the control circuits. Thus, the touch panel of the invention can further locate the position of the pen or finger more precisely. Therefore, although the sensor element of the invention may be much larger than the sensor element of the traditional touch panel, however, the touch panel of the invention can locate the position of the pen or finger precisely and the unit of the present invention may output multiple signals.

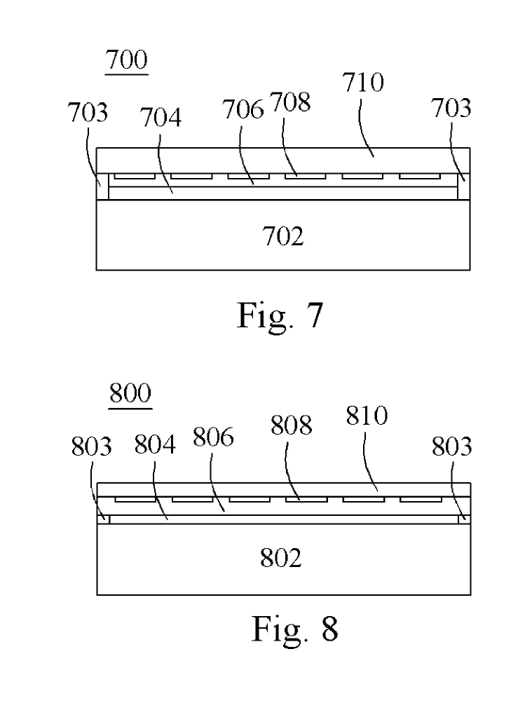

FIG. 7 illustrates the sectional view of a capacitive touch panel with the single pattern layer and the one glass solution structure according to another embodiment of the invention.

The capacitive touch panel comprises: a liquid crystal module 702 for displaying images and serving as a ground; and a pattern layer with sensor cells 708 positioned over the liquid crystal module 702 wherein the sensor cells 708 form a sensor array. The capacitive touch panel further comprises a lens 710 for covering the pattern layer.

The gaskets 703 are positioned between the lens 710 and the liquid crystal module 702. The spacer film 706 is used as a flexible dielectric layer, and positioned inside the gaskets 703 and under the pattern layer with the sensor cells 708. A gap 704 is formed between the spacer film 706 and the liquid crystal module 702 wherein the spacer film 706 and the lens 710 are flexible, and the gap 704 is used for allowing the deformation of the lens 710 and the spacer film 706.

The method to produce a capacitive touch panel with the single pattern layer and the one lens solution structure illustrated in FIG. 7 comprises the following steps of: forming a pattern layer with sensor cells 708 on a lens 710, wherein the lens 710 could be Poly(methyl methacrylate) (PMMA) for lowering cost in manufacturing; forming a spacer film 706 on the pattern layer with sensor cells 708; and turning the assembly of the lens 710, the pattern layer, and the spacer film 706 upside down to cover a liquid crystal module 702 with gaskets 703 positioned between the lens 710 and the liquid crystal module 702.

FIG. 8 illustrates the sectional view of a capacitive touch panel with Indium Tin Oxide (ITO) lens plus Polyethylene Terephthalate (PET) film structure according to another embodiment of the invention.

The capacitive touch panel 800 comprises: a liquid crystal module 802 for displaying images and serving as a ground; and a pattern layer with sensor cells 808 positioned over the liquid crystal module 802 wherein the sensor cells 808 form a sensor array.

The capacitive touch panel 800 further comprises: a lens 810 for covering the pattern layer; and a spacer film 806 used as a flexible dielectric layer and positioned between the liquid crystal module 802 and the lens 810, and under the pattern layer with the sensor cells 808.

There are gaskets 803 positioned between the spacer film 806 and the liquid crystal module 802, and thus a gap 804 is formed between the spacer film 806 and the liquid crystal module 802 wherein the spacer film 806 and the lens 810 are flexible, and the gap 804 is used for allowing the deformation of the lens 810 and the spacer film 806.

The method to produce a capacitive touch panel with Indium Tin Oxide (ITO) glass plus Polyethylene Terephthalate (PET) film structure illustrated in FIG. 8 comprises the following steps of: forming a pattern layer with sensor cells 808 on a lens 810, wherein the lens 810 could be Indium Tin Oxide (ITO) for cost reduction; forming a spacer film 806 on the pattern layer with sensor cells 808, wherein the spacer film 806 could be Polyethylene Terephthalate film; and turning the assembly of the lens 810, the pattern layer, and the spacer film 806 upside down to cover a liquid crystal module 802 with gaskets 803 positioned between the lens 810 and the liquid crystal module 802.

Further, the touch panel modules illustrated in FIGS. 7 and 8 may use the one-dimensional single layer honeycomb pattern as the ITO pattern.

Therefore, the invention provides the pen writing function on the one-dimensional touch sensor which can be used for the capacitive multi-touch function, and the pen writing function is similar to the writing of the normal pen. Further, the pen can be made of non-conductive material to exert the pressure on the touch screen, such that the detection of position is based on the capacitance variation of the mechanical bending from the writing pressure. Moreover, the liquid crystal module of the touch screen serves as the ground which is the reference for each sensor element.

The foregoing description, for purposes of explanation, was set forth in specific details of the preferred embodiments to provide a thorough understanding of the invention. However, it will be apparent to one skilled in the art that specific details are not required in order to practice the invention. Therefore, the foregoing descriptions of specific embodiments of the invention are presented for purposes of illustration and description only and should not be construed in any way to limit the scope of the invention. They are not intended to be exhaustive or to limit the invention to the precise forms disclosed; obviously, many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following Claims and their equivalents define the scope of the invention.

The above-described embodiments of the present invention are intended to be illustrative only. Numerous alternative embodiments may be devised by those skilled in the art without departing from the scope of the following claims.

What is claimed is:

1. A touch panel comprising:
a base serving as a ground;
a flexible dielectric layer over the base; and
a single pattern layer with sensor cells positioned over the flexible dielectric layer wherein the sensor cells form a sensor array,
wherein capacitance is electrically formed from each of the sensor cells to the base, and deformation of the flexible dielectric layer generated by applying an external force results in different capacitance of one of the sensor cells when the deformation makes distance from the one of the sensor cells to the base change.

2. The touch panel of claim 1, wherein variation of the capacitance caused in each place of the flexible dielectric layer is used for determining a position being touched.

3. The touch panel of claim 1 further comprising: a lens positioned over the sensor array for shielding the sensor array.

4. The touch panel of claim 1, wherein the sensor array is a one-dimensional sensor array.

5. The touch panel of claim 1, wherein the sensor cells are hexagon and are arranged to form a honeycomb sensor array.

6. The touch panel of claim 1, further comprising a pen to produce the external force.

7. A touch panel comprising:
a liquid crystal module for displaying images and serving as a ground;
a pattern layer with sensor cells positioned over the liquid crystal module wherein the sensor cells form a sensor array;
a lens positioned over the sensor array for shielding the sensor array;
gaskets positioned between the lens and the liquid crystal module; and
a spacer film positioned inside the gaskets and under the pattern layer such that a gap is formed between the spacer film and the liquid crystal module,
wherein the spacer film and the lens are flexible, and the gap is used for allowing deformation of the lens and spacer film; and
capacitance is electrically formed from each of the sensor cells to the liquid crystal module, and the capacitance varies when the pattern layer is bended by an external force.

8. The touch panel of claim 7, wherein different ones of the sensor cells in different places of the pattern layer have different capacitance to the liquid crystal module when the external force results different bending in the different places of the pattern layer and results different distances between the different ones of the sensor cells and the different places of the spacer film.

9. The touch panel of claim 7, wherein the sensor array is a one-dimensional sensor array.

10. The touch panel of claim 7, wherein the sensor cells are hexagon and are arranged to form a honeycomb sensor array.

11. The touch panel of claim 7, wherein the lens is Poly(methyl methacrylate).

12. A touch panel comprising:
a liquid crystal module for displaying images and serving as a ground;
a pattern layer with sensor cells positioned over the liquid crystal module wherein the sensor cells form a sensor array;
a lens for covering the pattern layer;
a spacer film positioned between the liquid crystal module and the lens, and under the pattern layer;
gaskets positioned between the spacer film and the liquid crystal module such that a gap is formed between the spacer film and the liquid crystal module,
wherein the spacer film and the lens are flexible, and the gap is used for allowing the deformation of the lens and the spacer film; and
capacitance is electrically formed from each of the sensor cells to the liquid crystal module, and the capacitance varies when the pattern layer is bended by an external force.

13. The touch panel of claim 12, wherein different ones of the sensor cells in different places of the pattern layer have different capacitance to the liquid crystal module when the external force results different bending in the different places of the pattern layer and results different distances between the different ones of the sensor cells and the different places of the spacer film.

14. The touch panel of claim 12, wherein the sensor array is a one-dimensional sensor array.

15. The touch panel of claim 12, wherein the sensor cells are hexagon and are arranged to form a honeycomb sensor array.

16. The touch panel of claim 12, wherein the lens is Indium Tin Oxide (ITO).

17. The touch panel of claim 12, wherein the spacer film is Polyethylene Terephthalate film.

18. The touch panel of claim 12, wherein the lens is a printing circuit board.

19. A method for producing a touch panel comprising steps of:
forming a base serving as a ground;
forming a flexible dielectric layer over the base; and
forming a single pattern layer with sensor cells of a sensor array positioned over the flexible dielectric layer,
wherein capacitance is electrically formed from each of the sensor cells to the base, and deformation of the flexible dielectric layer generated by applying an external force results in different capacitance of one of the sensor cells when the deformation makes distance from the one of the sensor cells to the base change.

20. The method of claim 19, wherein the sensor cells are hexagon and are arranged to form a honeycomb sensor array.
